(19) United States
(12) Patent Application Publication
(10) Pub. No.: US 2024/0054792 A1
(43) Pub. Date: Feb. 15, 2024

(54) METHOD FOR GENERATING A RULES PACKAGE DESCRIBING THE CURRENT TRAFFIC SITUATION OF A MOTOR VEHICLE, FROM TRAFFIC RULES BASED ON TRAFFIC SIGN RECOGNITION

(71) Applicant: Robert Bosch GmbH, Stuttgart (DE)

(72) Inventor: Anh Tuan Tran, Heilbronn (DE)

(21) Appl. No.: 18/446,704

(22) Filed: Aug. 9, 2023

(30) Foreign Application Priority Data
Aug. 15, 2022 (DE) 10 2022 208 441.1

(51) Int. Cl. G06V 20/58; G08G 1/01

(52) U.S. Cl. CPC G06V 20/582; G08G 1/0141

(57) ABSTRACT

A method for generating a rules package describing the current traffic situation of a motor vehicle. A traffic sign recognition unit monitors the area in front of the motor vehicle, and is used to generate video data. Traffic signs are recognized and an encoder/decoder unit generates first sensor data and transmits them to an evaluation unit, which encodes the recognized traffic sign. As a function of the first sensor data, the evaluation unit requests second sensor data, which characterize the current traffic situation, from at least one further sensor. In response, the encoder/decoder unit encodes these second sensor data, transmits them to the evaluation unit and the latter compares them along with the first sensor data to traffic rules stored in a database. Individual traffic rules are selected and from the selected rules. a rules package is created which contains the selected traffic rules.

### CROSS REFERENCE

The present application claims the benefit under 35 U.S.C. § 119 of German Patent Application No. DE 10 2022 208 441.1 filed on Aug. 15, 2022, which is expressly incorporated herein by reference in its entirety.

### FIELD

The present invention relates to a method for generating a rules package describing the current traffic situation of a motor vehicle, from traffic rules by means of traffic sign recognition. The present invention also relates to a control unit configured/programmed to perform this method, and to a motor vehicle comprising such a control unit.

### BACKGROUND INFORMATION

The automated recognition of traffic signs is in particular of great importance for the development of vehicle assistance systems of motor vehicles.

It proves to be problematic that, in practice, not only individual traffic signs must be correctly recognized and interpreted but often also a combination of two or more traffic signs. In the course of correct interpretation, it may also be necessary to consider further, in particular situation-specific parameters. For example, a speed limit traffic sign may only be applicable under certain conditions, e.g., at a particular time of day, or under particular environmental conditions, e.g., rain.

### SUMMARY

It is an object of the present invention to provide an improved method for traffic sign recognition, which takes into account the problems discussed above.

This object may be achieved by features of the present invention. Preferred example embodiments of the present invention are disclosed herein.

The method according to the present invention presented here is used to generate a rules package describing the current traffic situation of a motor vehicle, from traffic rules based on traffic sign recognition. According to an example embodiment of the present invention, in the method, a traffic sign recognition unit for traffic sign recognition, which monitors the area in front of the motor vehicle, is used to generate video data that contain images of the area in front of the vehicle. In addition, according to the method, traffic signs present in the video data or in the images are recognized, and first sensor data describing the recognized traffic sign are encoded therefrom by an encoder/decoder unit and transmitted to an evaluation unit. According to the method, in the course of an evaluation of the first sensor data, the evaluation unit requests second sensor data, which characterize the current traffic situation in the vicinity of the motor vehicle, from at least one further sensor as a function of the first sensor data. In response to this request of the evaluation unit, the adapted sensor fusion unit encodes corresponding second sensor data and transmits them to the evaluation unit and the latter compares them along with the first sensor data to traffic rules stored in a database. In the course of this comparison and as a function of the first and second sensor data, individual traffic rules are selected and from the selected traffic rules is created a rules package, the traffic rules of which can or must be considered as currently applicable to the motor vehicle and thus in the control of the motor vehicle, whether by the driver thereof or by a vehicle assistance system present in the motor vehicle.

In a preferred example embodiment of the present invention, the database is an external cloud database. Such an external cloud database may be used, and also maintained and updated, by a variety of users. This improves the quality of the cloud database in terms of quantity and content, which also benefits the method according to the present invention.

According to an example embodiment of the present invention, preferably, the evaluation unit evaluates the first and second sensor data by means of machine learning, in particular by using a deep learning system. This can continuously improve the quality of the evaluation of the sensor data.

According to an advantageous development of the method according to the present invention, the first and second sensor data are generated by means of an encoder/decoder unit and a sensor fusion unit, which communicates with the at least one further sensor via an in-vehicle field bus. This allows vehicle-specific sensors to be used.

According to a further advantageous development of the present invention, the rules package generated by the evaluation device is transmitted with the traffic rules from the evaluation unit to the encoder/decoder unit and passed on to the in-vehicle field bus of the motor vehicle after decoding.

Particularly preferably, according to an example embodiment of the present invention, the first sensor data may comprise information regarding at least one further object contained or recognized in the video data.

Particularly preferably, according to an example embodiment of the present invention, the second sensor data may comprise information regarding the current weather situation or/and the traffic situation or/and the current time or/and the current date in the vicinity of the motor vehicle.

Particularly expediently, according to an example embodiment of the present invention, the at least one further item of information comprises or is a current traffic situation in the vicinity of the motor vehicle or/and a current weather situation in the vicinity of the motor vehicle or/and a current time or/and a current date.

The present invention also relates to a control unit for a motor vehicle configured/programmed to perform the method according to the present invention. The advantages explained above of the method according to the present invention therefore apply to the control unit according to the present invention.

The present invention also relates to a motor vehicle with a control unit according to the present invention so that the advantages explained above of the method according to the present invention also apply to the motor vehicle according to the present invention.

Further important features and advantages of the present invention become apparent from the disclosure herein.

It is understood that the aforementioned features and the features yet to be explained below can be used not only in the respectively specified combination but also in other combinations, or alone, without departing from the scope of the present invention.

Preferred exemplary embodiments of the present invention are illustrated in the figure and explained in more detail in the description below, wherein identical reference signs refer to identical or similar or functionally identical components.

### BRIEF DESCRIPTION OF THE DRAWING

FIG. 1 illustrates the structure of a control unit 1 according to an example embodiment of the present invention.

### DETAILED DESCRIPTION OF EXAMPLE EMBODIMENTS

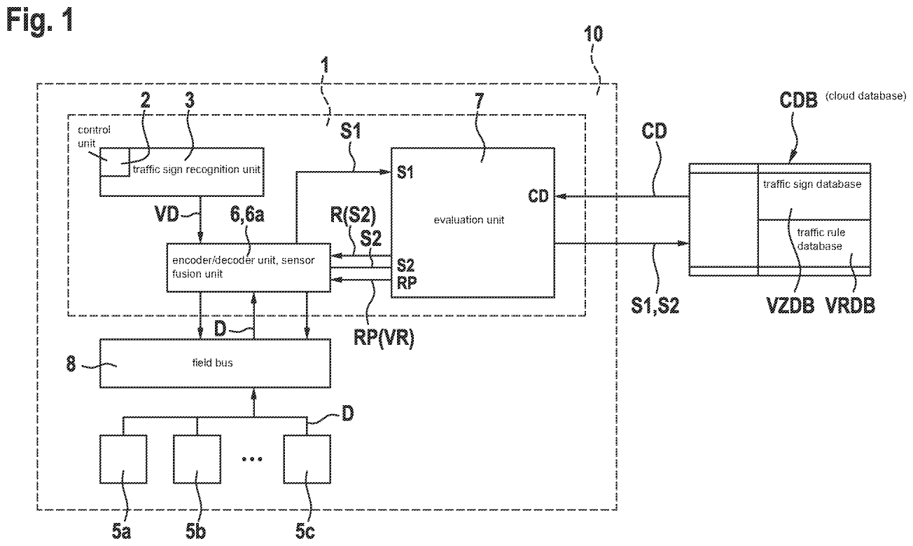

By way of example, the single FIG. 1 illustrates the structure of a control unit 1 according to the present invention, which is part of a motor vehicle 10 according to the present invention and is configured and programmed to perform the method according to the present invention. The method according to the present invention is used to generate a rules package from traffic rules that describe the current traffic situation of the motor vehicle 10.

For this purpose, the motor vehicle 10 comprises a traffic sign recognition unit 3 for monitoring the area in front of the vehicle in data transmission connection with the control unit 1. The traffic sign recognition unit 3 comprises a video sensor 2, which generates images of the area in front of the motor vehicle 10, which images may contain traffic signs. For traffic sign recognition, the traffic sign recognition unit 3 thus monitors the area in front of the vehicle 10 and, during operation, generates video data VD, which encode the images of the area in front of the vehicle. These video data are transmitted from the traffic sign recognition unit 3 to an encoder/decoder unit 6, which processes them further. This encoder/decoder unit 6 comprises a sensor fusion unit 6a, which consolidates the other sensors and transforms them into the same form.

In addition, the motor vehicle 10 comprises further sensors 5a-5c, e.g., a rain sensor, a speed sensor and a position sensor. These sensors 5a-5c communicate with the encoder/decoder unit 6 via a field bus 8, e.g., via a LIN or CAN bus, of the motor vehicle 10. The data D generated by the sensors 5a-5c can thus be transmitted via the field bus 8 to the sensor fusion unit 6a and processed by the later and subsequently decoded by the encoder/decoder unit 6.

From the video data VD generated by the traffic sign recognition unit 3, the encoder/decoder unit 6 generates first sensor data S1, which contain information regarding the traffic sign(s) recognized in the video data, and transmits them to an evaluation unit 7. The first sensor data S1 may contain: all recognized traffic sign objects in the video data, also with confidence value; the positions of the so-called bounding box, timestamps, metadata such as object shapes, colors. The first sensor data S1 may also contain information regarding further objects contained in the video data, in particular in the form of further traffic signs, which were generated by the encoder/decoder unit 6.

As a function of the information contained in the first sensor data S1, the evaluation unit 7 requests, from the encoder/decoder unit 6, second sensor data S2, which were generated from the data D which were generated by the sensors 5a-5c and characterize the current traffic situation in the environment of the motor vehicle 10. In order to generate this request R(S2), the evaluation unit 7 searches for relevant sensors by means of which the current traffic situation can be described. For example, depending on the addition of a speed limit specified in the recognized traffic sign, the evaluation unit 7 must search for other sensors, such as a rain sensor or front camera/lidar or the like.

Like the first sensor data S1, the second sensor data S2 based on the data D of the sensors 5a-5c are also generated by the sensor fusion unit 6a and subsequently by the encoder/decoder unit 6 and transmitted to the evaluation unit 7.

The evaluation unit 7 in turn now compares the second sensor data S2 along with the first sensor data S1 to rules stored in an external cloud database CDB. For this purpose, the cloud database CDB transmits cloud data CD regarding traffic signs and traffic rules VR assigned to these traffic signs, to the evaluation unit 7.

The cloud database CDB comprises cloud data CD, which are maintained by traffic experts. In particular, the cloud database CDB comprises a traffic sign database VZDB and a traffic rule database VRDB. The traffic sign database VZDB consists of international traffic signs, including information such as sign prototype images, shapes, colors, pictograms, related traffic conventions (Vienna, MUTCD, etc.) and the categories (prohibition, warning, mandatory signage, emergency). The traffic sign database VZDB also contains relationships between the traffic signs. Moreover, each traffic sign may be coupled to an associated sensor. For example, a speed limit traffic sign can be linked to an additional traffic sign “(only) in wet weather” and this link itself is linked to a wetness sensor.

In the course of the comparison and as a function of the first and second sensor data S1, S2, the evaluation unit 7 selects individual traffic rules VR corresponding to the first and second sensor data S1, S2, from the cloud data CD obtained from the cloud database CDB. From these selected traffic rules, a rules package RP is created which contains the selected traffic rules as package elements. The generated rules package RP is transmitted from the evaluation unit 7 to the encoder/decoder unit 6 and passed on to the in-vehicle field bus 8 so that the rules package RP can be further processed by further control units (not shown) of the motor vehicle 10 that are connected to the field bus 8. For example, a rules package RP may contain the following traffic rules:—effective speed limit of the lane currently traveled by the motor vehicle; —list of the prohibitions specified on the traffic signs and indication as to which of the prohibitions may be violated; —list of the warnings specified on the traffic signs; —list of the mandatory actions specified on the traffic signs and indication as to which of the mandatory actions may be violated.

The second sensor data S2 may comprise information regarding the current weather situation or/and the traffic situation or/and the current time or/and the current date in the vicinity of the motor vehicle 10.

What is claimed is:

1. A method for generating a rules package describing a current traffic situation of a motor vehicle, from traffic rules based on traffic sign recognition, the method comprising the following steps:
using a traffic sign recognition unit for traffic sign recognition, which monitors an area in front of the motor vehicle, to generate video data that contain images of the area in front of the vehicle;
recognizing a traffic sign present in the video data or in the images, generating first sensor data using an encoder/decoder unit from the recognized traffic sign, and transmitting the first sensor data to an evaluation unit, which encodes the recognized traffic sign;
requesting as a function of the first sensor data, by the evaluation unit, second sensor data, which characterize the current traffic situation in the vicinity of the motor vehicle, from at least one further sensor;
in response to this request, encoding by a sensor fusion unit and subsequently the encoder/decoder unit, the second sensor data, and transmitting the second sensor data to the evaluation unit, the evaluation unit comparing the sensor data along with the first sensor data, to traffic rules stored in a database; and
selecting, in the course of the comparison and as a function of the first and second sensor data, individual traffic rules, and creating, from the selected rules, a rules package which contains the selected traffic rules.

2. The method according to claim 1, wherein the database is an external cloud database which stores rules assigned to information contained in the first and second sensor data.

3. The method according to claim 1, wherein the evaluation unit evaluates the first and second sensor data using machine learning.

4. The method according to claim 1, wherein the first and second sensor data are generated using the encoder/decoder unit, which communicates with the at least one further sensor via an in-vehicle field bus.

5. The method according to claim 1, wherein the generated rules package is transmitted from the evaluation unit to the encoder/decoder unit and passed on by the encoder/decoder unit to the in-vehicle field bus after decoding.

6. The method according to claim 1, wherein the first sensor data include data regarding at least one further object contained or recognized in the video data.

7. The method according to claim 1, wherein the second sensor data include data regarding a current weather situation or/and the traffic situation or/and a current time or/and a current date in the vicinity of the motor vehicle.

8. The method according to claim 7, wherein the second sensor data regard:
the current traffic situation in the vicinity of the motor vehicle,
the current weather situation in the vicinity of the motor vehicle,
the current time or/and the current date.

9. A control unit for a motor vehicle, the control unit configured to generate a rules package describing a current traffic situation of a motor vehicle, from traffic rules based on traffic sign recognition, the control unit configured to:
use a traffic sign recognition unit for traffic sign recognition, which monitors an area in front of the motor vehicle, to generate video data that contain images of the area in front of the vehicle;
recognize a traffic sign present in the video data or in the images, generate first sensor data using an encoder/decoder unit from the recognized traffic sign, and transmit the first sensor data to an evaluation unit, which encodes the recognized traffic sign;
request as a function of the first sensor data, by the evaluation unit, second sensor data, which characterize the current traffic situation in the vicinity of the motor vehicle, from at least one further sensor;
in response to this request, encode by a sensor fusion unit and subsequently the encoder/decoder unit, the second sensor data, and transmit the second sensor data to the evaluation unit, the evaluation unit comparing the sensor data along with the first sensor data, to traffic rules stored in a database; and
select, in the course of the comparison and as a function of the first and second sensor data, individual traffic rules, and create, from the selected rules, a rules package which contains the selected traffic rules.

10. A motor vehicle, comprising:
a control unit configured to generate a rules package describing a current traffic situation of a motor vehicle, from traffic rules based on traffic sign recognition, the control unit configured to:
use a traffic sign recognition unit for traffic sign recognition, which monitors an area in front of the motor vehicle, to generate video data that contain images of the area in front of the vehicle;
recognize a traffic sign present in the video data or in the images, generate first sensor data using an encoder/decoder unit from the recognized traffic sign, and transmit the first sensor data to an evaluation unit, which encodes the recognized traffic sign;
request as a function of the first sensor data, by the evaluation unit, second sensor data, which characterize the current traffic situation in the vicinity of the motor vehicle, from at least one further sensor;
in response to this request, encode by a sensor fusion unit and subsequently the encoder/decoder unit, the second sensor data, and transmit the second sensor data to the evaluation unit, the evaluation unit comparing the sensor data along with the first sensor data, to traffic rules stored in a database; and
select, in the course of the comparison and as a function of the first and second sensor data, individual traffic rules, and create, from the selected rules, a rules package which contains the selected traffic rules;
the traffic sign recognition unit, configured to monitor the area in front of the motor vehicle, in data transmission connection with the control unit; and
at least one video sensor, configured to ascertain an environmental parameter characterizing an environment of the motor vehicle, in data transmission connection with the control unit.
